(19) United States
(12) Patent Application Publication
(10) Pub. No.: US 2025/0014498 A1
(43) Pub. Date: Jan. 9, 2025

(54) DISPLAY APPARATUS AND A METHOD OF DRIVING THE SAME

(71) Applicant: SAMSUNG DISPLAY CO., LTD., YONGIN-SI (KR)

(72) Inventors: JAEKEUN LIM, Yongin-si (KR); BON-SEOG GU, Yongin-si (KR); JIYOUN KIM, Yongin-si (KR); JINYOUNG ROH, Yongin-si (KR); HAE-KWAN SEO, Yongin-si (KR)

(21) Appl. No.: 18/743,206

(22) Filed: Jun. 14, 2024

(30) Foreign Application Priority Data
Jul. 5, 2023 (KR) 10-2023-0087037

(51) Int. Cl. G09G 3/20

(52) U.S. Cl. CPC G09G 3/2092; G09G 2310/0267; G09G 2310/0275; G09G 2310/08; G09G 2330/021

(57) ABSTRACT

A display apparatus including: a display panel including a first direction data line extending in a first direction, a plurality of second direction data lines extending in a second direction different from the first direction, a gate line extending in the second direction and a pixel connected to the first direction data line and the gate line; a gate driver configured to apply a gate signal to the gate line; and a data driver configured to apply a data voltage to the second direction data lines.

### CROSS-REFERENCE TO RELATED APPLICATION

This application claims priority under 35 U.S.C. § 119 to Korean Patent Application No. 10-2023-0087037, filed on Jul. 5, 2023 in the Korean Intellectual Property Office (KIPO), the disclosure of which is incorporated by reference herein in its entirety.

### 1. TECHNICAL FIELD

Embodiments of the present inventive concept relate to a display apparatus and a method of driving the display apparatus.

### 2. DESCRIPTION OF THE RELATED ART

A display apparatus typically includes a display panel and a display panel driver. The display panel displays an image using input image data and consists of multiple gate lines, data lines and pixels. The display panel driver includes two main components: a gate driver, which sends signals to the gate lines, and a data driver, responsible for delivering data voltages to the data lines.

A special-purpose display panel, such as a display panel used inside an automobile, often features a significantly higher horizontal resolution compared to a standard display panel. However, driving the special-purpose display panel with a conventional gate driver and a conventional data driver can lead to challenges. For instance, the number of source driver chips may increase, potentially raising manufacturing costs. Additionally, a frequency division driving method may not be employed due to a mismatch between the type of content used and the scanning direction.

### SUMMARY

Embodiments of the present inventive concept provide a display apparatus including a structure in which a plurality of second direction data lines extending in a second direction are connected to one first direction data line extending in a first direction to reduce a manufacturing cost of the display apparatus. The display apparatus according to embodiments of the present inventive concept support a frequency division driving method.

Embodiments of the present inventive concept also provide a method of driving the display apparatus.

A display apparatus according to an embodiment of the present inventive concept includes: a display panel including a first direction data line extending in a first direction, a plurality of second direction data lines extending in a second direction different from the first direction, a gate line extending in the second direction and a pixel connected to the first direction data line and the gate line; a gate driver configured to apply a gate signal to the gate line; and a data driver configured to apply a data voltage to the second direction data lines.

The display panel includes a first display area, a second display area disposed adjacent to the first display area in the first direction and a third display area disposed adjacent to the second display area in the first direction, and wherein the first display area, the second display area and the third display area are driven with independent frequencies.

A gate signal applied to the first display area, a gate signal applied to the second display area and a gate signal applied to the third display area are independently applied.

The display panel includes: a first first direction data line extending in the first direction; a first second direction data line, a second second direction data line and a third second direction data line which are connected to the first first direction data line; a second first direction data line extending in the first direction; a fourth second direction data line, a fifth second direction data line and a sixth second direction data line which are connected to the second first direction data line; a third first direction data line extending in the first direction; and a seventh second direction data line, an eighth second direction data line and a ninth second direction data line which are connected to the third first direction data line, wherein the first direction data line includes the first first direction data line, the second first direction data line and the third first direction data line.

The first first data line includes a first inclined portion and a second inclined portion, and wherein the third first data line includes a third inclined portion.

The display panel includes: a 1-1 first direction data line extending in the first direction; a first second direction data line which is connected to the 1-1 first direction data line; a 1-2 first direction data line extending in the first direction and spaced apart from the 1-1 first direction data line; a second second direction data line and a third second direction data line which are connected to the 1-2 first direction data line; a second first direction data line extending in the first direction; a fourth second direction data line, a fifth second direction data line and a sixth second direction data line which are connected to the second first direction data line; a third first direction data line extending in the first direction; a seventh second direction data line and an eighth second direction data line which are connected to the third first direction data line; a fourth first direction data line extending in the first direction; and a ninth second direction data line which is connected to the fourth first direction data line, wherein the first direction data line includes the 1-1 first direction data line, the 1-2 first direction data line, the second first direction data line, the third first direction data line and the fourth first direction data line.

The gate driver extends along a first side of the display panel that extends in the first direction, and wherein the data driver extends along the first side of the display panel.

The gate driver is adjacent to a first side of the display panel, and wherein the data driver includes a plurality of source driving chips connected to the first side of the display panel.

The data driver includes a plurality of source driving chips connected to the display panel, and the display apparatus further includes a plurality of source switches disposed between the source driving chips and the second direction data lines.

The source switches are integrated on the display panel.

The source switches are integrated in the source driving chip.

The data driver includes a first source group corresponding to a first display area of the display panel and a second source group corresponding to a second display area of the display panel, wherein the first source group includes a plurality of first source driving chips, and wherein the second source group includes a plurality of second source driving chips, the display apparatus further including a plurality of first source group switches disposed between the first source driving chips and the second direction data lines in the first display area and a plurality of second source group switches disposed between the second source driving chips and the second direction data lines in the second display area.

The first source group switches are turned on and the second source group switches are turned on in a first period, and wherein the first source group switches are turned on and the second source group switches are turned off in a second period.

A data voltage is less than a target voltage in the first period, wherein the data voltage is equal to or greater than the target voltage in the second period, and wherein a first data voltage applied to the first source driving chips is the same as a second data voltage applied to the second source driving chips for the same grayscale value.

The first period is an overdriving period, wherein the second period is a normal driving period, and wherein a first data voltage applied to the first source driving chips is different from a second data voltage applied to the second source driving chips for the same grayscale value.

The display panel includes a first pixel and a second pixel which are disposed in a first pixel row and a third pixel and a fourth pixel which are disposed in a second pixel row, wherein the first pixel is connected to a first gate line and a 1-1 first direction data line, wherein the second pixel is connected to the first gate line and a 1-2 first direction data line, wherein the third pixel is connected to the first gate line and a 2-1 first direction data line, wherein the fourth pixel is connected to the first gate line and a 2-2 first direction data line, and wherein the first direction data line includes the 1-1 first direction data line, the 1-2 first direction data line, the 2-1 first direction data line and the 2-2 first direction data line.

A method of driving a display apparatus includes: outputting a gate signal to a gate line of a display panel including a first direction data line extending in a first direction, a plurality of second direction data lines extending in a second direction different from the first direction, and a pixel connected to the first direction data line and the gate line, wherein the gate line extends in the second direction; and outputting a data voltage to the second direction data lines.

The display panel includes a first display area, a second display area disposed adjacent to the first display area in the first direction and a third display area disposed adjacent to the second display area in the first direction, and wherein the first display area, the second display area and the third display area are driven with independent frequencies.

A gate signal applied to the first display area, a gate signal applied to the second display area and a gate signal applied to the third display area are independently applied.

A data driver include a first source group corresponding to a first display area of the display panel and a second source group corresponding to a second display area of the display panel, wherein the first source group include a plurality of first source driving chips, wherein the second source group includes a plurality of second source driving chips, wherein a plurality of first source group switches disposed between the first source driving chips and the second direction data lines in the first display area are turned on and a plurality of second source group switches disposed between the second source driving chips and the second direction data lines in the second display area are turned on in a first period, and wherein the first source group switches are turned on and the second source group switches are turned off in a second period.

According to the display apparatus and the method of driving the display apparatus of embodiments of the present inventive concept, the display panel includes a structure in which the plurality of second direction data lines extending in the second direction are connected to the one first direction data line extending in the first direction. As a consequence, the number of the source driving chips may be reduced in the display panel having the high resolution in the horizontal direction to reduce a manufacturing cost.

In addition, the gate driver and the data driver of embodiments of the present inventive concept may extend in the horizontal direction across the display panel that has the high resolution in the horizontal direction. This arrangement ensures that the content usage type and the scan direction are the same enabling the implementation of the frequency division driving method in which the plurality of the display areas are driven with different driving frequencies.

### BRIEF DESCRIPTION OF THE DRAWINGS

The above and other features of the present inventive concept will become more apparent by describing in detail embodiments thereof with reference to the accompanying drawings, in which:

FIG. 1 is a block diagram illustrating a display apparatus according to an embodiment of the present inventive concept;

FIGS. 2A, 2B, 2C and 2D are diagrams illustrating various content usage types of a display panel of FIG. 1;

FIG. 3 is a diagram illustrating an example of the display panel, a gate driver and a data driver of FIG. 1;

FIG. 4 is a diagram illustrating an example of the display panel, the gate driver and the data driver of FIG. 1;

FIG. 5 is a diagram illustrating an example of the display panel, the gate driver and the data driver of FIG. 1;

FIG. 6 is a diagram illustrating an example of an area A of FIG. 3;

FIG. 7 is a diagram illustrating a connection between first direction data lines, gate lines and pixels of the display panel of FIG. 1;

FIG. 8A is a diagram illustrating an example of an area A of FIG. 3;

FIG. 8B is a diagram illustrating an example of an area A of FIG. 3;

FIG. 9 is a timing diagram illustrating a method of controlling a switch of a first source group, a switch of a second source group and a switch of a third source group in the structures of FIGS. 8A and 8B;

FIG. 10 is a timing diagram illustrating a method of controlling the switch of the first source group, the switch of the second source group and the switch of the third source group in the structures of FIGS. 8A and 8B;

FIG. 11 is a diagram illustrating a connection between first direction data lines, gate lines and pixels of a display panel according to an embodiment of the present inventive concept; and

FIG. 12 is a block diagram illustrating an electronic apparatus according to an embodiment of the present inventive concept.

### DETAILED DESCRIPTION OF THE EMBODIMENTS

Hereinafter, embodiments of the present inventive concept will be explained in detail with reference to the accompanying drawings.

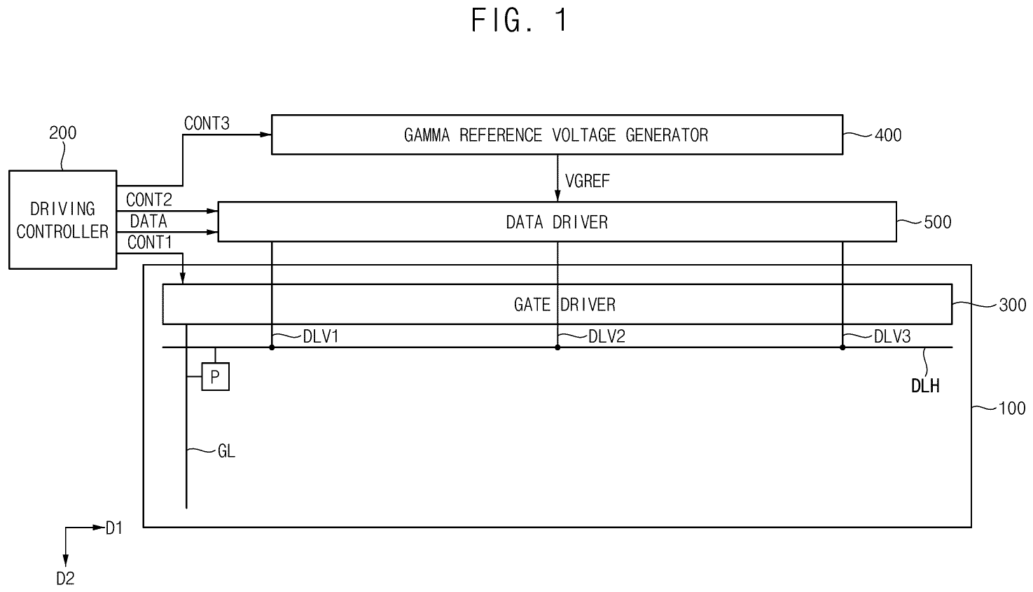

FIG. 1 is a block diagram illustrating a display apparatus according to an embodiment of the present inventive concept.

Referring to FIG. 1, the display apparatus includes a display panel 100 and a display panel driver. The display panel driver includes a driving controller 200, a gate driver 300, a gamma reference voltage generator 400 and a data driver 500.

For example, the driving controller 200 and the data driver 500 may be integrally formed. For example, the driving controller 200, the gamma reference voltage generator 400 and the data driver 500 may be integrally formed. A driving module including at least the driving controller 200 and the data driver 500, which are integrally formed, may be referred to as a timing controller embedded data driver (TED).

The display panel 100 has a display region on which an image is displayed and a peripheral region adjacent to the display region.

The display panel 100 includes a first direction data line DLH extending in a first direction D1, a plurality of second direction data lines DLV1, DLV2 and DLV3 extending in a second direction D2 different from the first direction D1, a gate line GL extending in the second direction D2 and a pixel P connected to the first direction data line DLH and the gate line GL.

The driving controller 200 receives input image data and an input control signal from an external apparatus. The input image data may include red image data, green image data and blue image data. The input image data may include white image data. The input image data may include magenta image data, yellow image data and cyan image data. The input control signal may include a master clock signal and a data enable signal. The input control signal may further include a vertical synchronizing signal and a horizontal synchronizing signal.

The driving controller 200 generates a gate control signal CONT1, a data control signal CONT2, a gamma control signal CONT3 and a data signal DATA based on the input image data and the input control signal.

The driving controller 200 generates the gate control signal CONT1 for controlling an operation of the gate driver 300 based on the input control signal, and outputs the gate control signal CONT1 to the gate driver 300. The gate control signal CONT1 may include a vertical start signal and a gate clock signal.

The driving controller 200 generates the data control signal CONT2 for controlling an operation of the data driver 500 based on the input control signal, and outputs the data control signal CONT2 to the data driver 500. The data control signal CONT2 may include a horizontal start signal and a load signal.

The driving controller 200 generates the data signal DATA based on the input image data. The driving controller 200 outputs the data signal DATA to the data driver 500.

The driving controller 200 generates the gamma control signal CONT3 for controlling an operation of the gamma reference voltage generator 400 based on the input control signal, and outputs the gamma control signal CONT3 to the gamma reference voltage generator 400.

The gate driver 300 generates gate signals driving the gate lines GL in response to the gate control signal CONT1 received from the driving controller 200. The gate driver 300 outputs the gate signals to the gate lines GL. For example, the gate driver 300 may sequentially output the gate signals to the gate lines GL. For example, the gate driver 300 may be mounted on the peripheral region of the display panel 100. For example, the gate driver 300 may be integrated on the peripheral region of the display panel 100.

The gamma reference voltage generator 400 generates a gamma reference voltage VGREF in response to the gamma control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500. In other words, the gamma reference voltage generator 400 may be integral with the driving controller 200, or the data driver 500.

The data driver 500 receives the data control signal CONT2 and the data signal DATA from the driving controller 200, and receives the gamma reference voltages VGREF from the gamma reference voltage generator 400. The data driver 500 converts the data signal DATA into data voltages having an analog form using the gamma reference voltages VGREF. The data driver 500 outputs the data voltages to the second direction data lines DLV1, DLV2 and DLV3.

The gate driver 300 may extend along a first side of the display panel 100. For example, the gate driver 300 may be extended in the first direction D1. In addition, the data driver 500 may extend along the first side of the display panel 100. Although the gate driver 300 is disposed on an upper end portion of the peripheral region of the display panel 100 and the data driver 100 is disposed adjacent to an upper side of the display panel 100 in FIG. 1, the present inventive concept may not be limited thereto. For example, the gate driver 300 may be disposed on a lower end portion of the peripheral region of the display panel 100 or disposed on both of the upper end portion and the lower end portion of the peripheral region of the display panel 100. In addition, the data driver 500 may be disposed adjacent to a lower side of the display panel 100 or the data driver 500 may be disposed adjacent to the upper side and the lower side of the display panel 100.

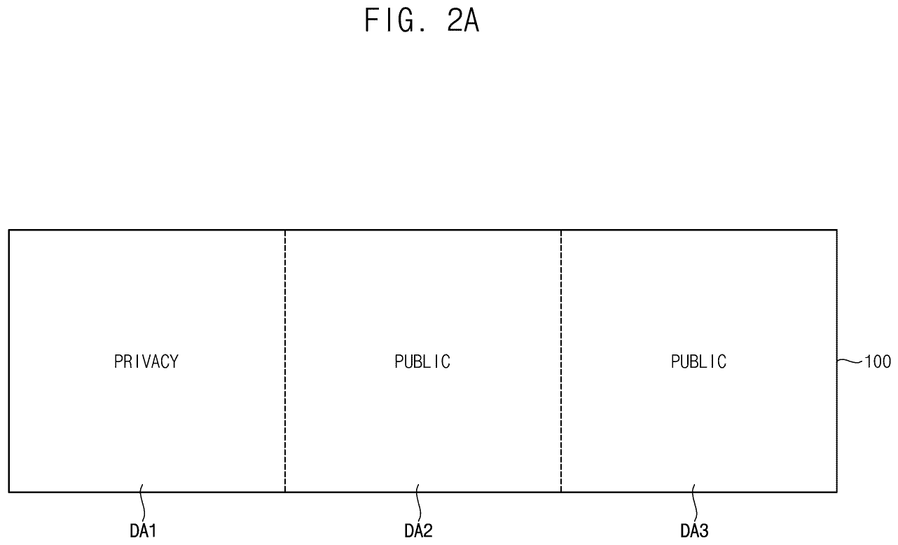

FIGS. 2A to 2D are diagrams illustrating various content usage types of the display panel 100 of FIG. 1.

Referring to FIGS. 1 to 2D, the display panel 100 may have a high resolution in the first direction D1. For example, the display panel 100 may be an automotive display panel used inside an automobile.

For example, the display panel 100 may include a first display area DA1, a second display area DA2 disposed adjacent to the first display area DA1 in the first direction D1 and a third display area DA3 disposed adjacent to the second display area DA2 in the first direction D1. The second display area DA2 may be located between the first and third display areas DA1 and DA3.

For example, the first display area DA1 is a display area of the automotive display panel corresponding to a driver's seat. For example, the third display area DA3 is a display area of the automotive display panel corresponding to a passenger's seat that is next to the driver's seat. For example, the second display area DA2 is a display area of the automotive display panel corresponding to a common portion between the driver's seat and the passenger's seat. In other words, the second display area DA2 corresponds to an area between the driver's seat and the passenger's seat.

The first display area DA1, the second display area DA2 and the third display area DA3 may be driven with independent frequencies. For example, when the first display area DA1 displays a still image and the third display area DA3 displays a moving image, the first display area DA1 may be driven with a low frequency and the third display area DA3 may be driven with a high frequency.

Gate signals applied to the first display area DA1, gate signals applied to the second display area DA2 and gate signals applied to the third display area DA3 may be independently applied. For example, the gate signals applied to the first display area DA1, the gate signals applied to the second display area DA2 and the gate signals applied to the third display area DA3 may be independently masked.

As shown in FIG. 2A, the first display area DA1 may have a privacy mode, the second display area DA2 may have a public mode and the third display area DA3 may have the public mode.

As shown in FIG. 2B, the first display area DA1 may have the public mode, the second display area DA2 may have the public mode and the third display area DA3 may have the privacy mode.

As shown in FIG. 2C, the first display area DA1 may have the privacy mode, the second display area DA2 may have the public mode and the third display area DA3 may have the privacy mode.

As shown in FIG. 2D, the first display area DA1 may have the public mode, the second display area DA2 may have the public mode and the third display area DA3 may have the public mode.

Although the display panel 100 is divided into three display areas DA1, DA2 and DA3 in FIGS. 2A to 2D, the present inventive concept may not be limited thereto. For example, the display panel 100 may be divided into two display areas or four or more display areas. Although the display areas DA1, DA2 and DA3 are disposed in the first direction D1 in FIGS. 2A to 2D, the present inventive concept may not be limited thereto. For example, the display areas may be divided to be disposed in the second direction D2 or divided to be disposed in the first direction D1 and the second direction D2 or divided to be disposed in a direction different from the first direction D1 and the second direction D2.

For example, each of the display areas DA1, DA2 and DA3 may have a wide viewing angle in the public mode so that the display area may be visible to a person located on sides of the display area. For example, each of the display areas DA1, DA2 and DA3 may have a narrow viewing angle in the privacy mode so that the display area may not be visible to a person located on sides of the display area.

In the present embodiment, the gate driver 300 extends along a longer side of the display panel 100. This arrangement aligns both the content usage type, which is determined by the orientation of the first, second and third display areas DA1, DA2 and D3, and the scan direction with the first direction D1. Thus, the frequency division driving method in which the plurality of the display areas DA1, DA2 and DA3 are driven in different driving frequencies may be applied to the display apparatus.

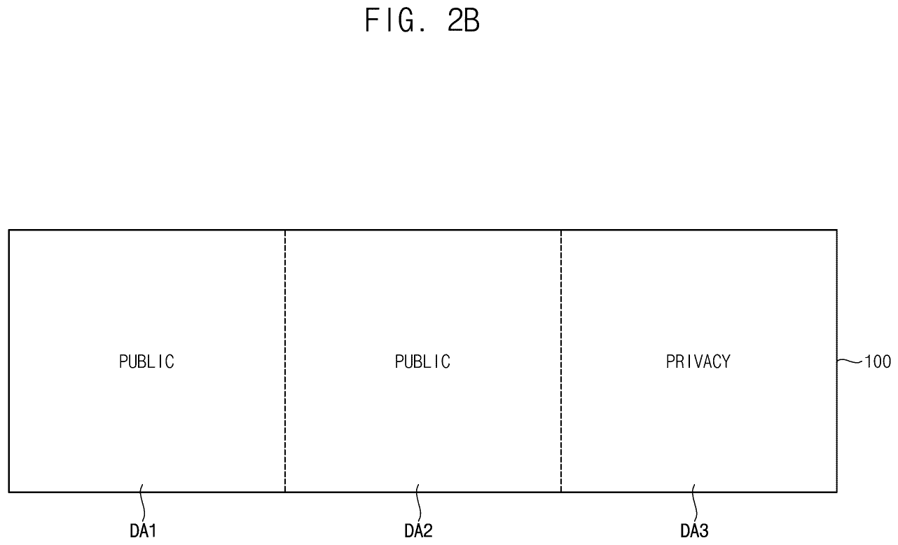

FIG. 3 is a diagram illustrating an example of the display panel 100, the gate driver 300 and the data driver 500 of FIG. 1.

Referring to FIGS. 1 to 3, the gate driver 300 may be integrated on the display panel 100 such that the gate driver 300 is adjacent to the first side of the display panel 100. In addition, the data driver 500 may include a plurality of source driving chips S1, S2, S3, S4, S5, S6, S7, S8 and S9 connected to the first side of the display panel 100.

The data driver 500 may include a first source group SG1, a second source group SG2 and a third source group SG3. For example, the first source group SG1 may correspond to the first display area DA1, the second source group SG2 may correspond to the second display area DA2 and the third source group SG3 may correspond to the third display area DA3. Although the display panel 100 includes three display areas and the data driver 500 includes three source groups in FIGS. 2A to 3, the present inventive concept may not be limited thereto. For example, the display panel 100 may include two display areas and the data driver 500 may include two source groups. For example, the display panel 100 may include four or more display areas and the data driver 500 may include four or more source groups.

The first source group SG1 may include first source driving chips S1, S2 and S3. The second source group SG2 may include second source driving chips S4, S5 and S6. The third source group SG3 may include third source driving chips S7, S8 and S9.

In the present embodiment, the first source group SG1 may further include a first printed circuit board PCB1 connected to the first source driving chips S1, S2 and S3. The second source group SG2 may further include a second printed circuit board PCB2 connected to the second source driving chips S4, S5 and S6. The third source group SG3 may further include a third printed circuit board PCB3 connected to the third source driving chips S7, S8 and S9.

As shown in FIG. 3, the display panel 100 may include a first first direction data line DLH1 extending in the first direction D1, a first second direction data line DLV11, a second second direction data line DLV12 and a third second direction data line DLV13 which are connected to the first first direction data line DLH1. The display panel 100 may also include a second first direction data line DLH2 extending in the first direction D1, a fourth second direction data line DLV21, a fifth second direction data line DLV22 and a sixth second direction data line DLV23 which are connected to the second first direction data line DLH2. The display panel 100 may further include a third first direction data line DLH3 extending in the first direction D1, a seventh second direction data line DLV31, an eighth second direction data line DLV32 and a ninth second direction data line DLV33 which are connected to the third first direction data line DLH3.

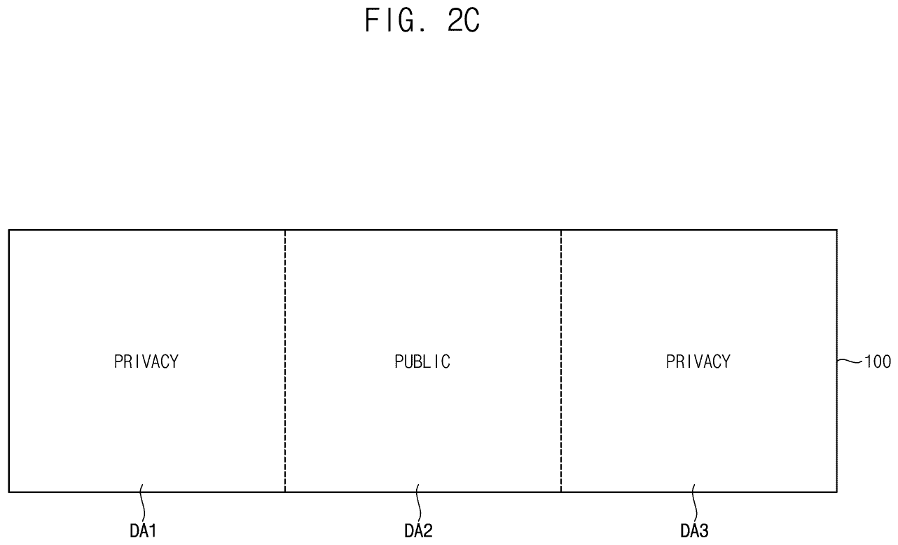

FIG. 4 is a diagram illustrating an example of the display panel 100A, the gate driver 300 and the data driver 500 of FIG. 1.

Referring to FIGS. 1, 2A to 2D and 4, a shape of the display panel 100A may not be a rectangle. An outline of the display panel 100A may include an inclined portion and a curved portion.

The first source group SG1 may include a plurality of first source driving chips S1, S2 and S3. The second source group SG2 may include a plurality of second source driving chips S4, S5 and S6. The third source group SG3 may include a plurality of third source driving chips S7, S8 and S9.

In the present embodiment, the first source group SG1 may further include first printed circuit boards PCB11 and PCB12 connected to the first source driving chips S1, S2 and S3. The second source group SG2 may further include a second printed circuit board PCB2 connected to the second source driving chips S4, S5 and S6. The third source group SG3 may further include a third printed circuit board PCB3 connected to the third source driving chips S7, S8 and S9.

As shown in FIG. 4, the display panel 100A may include a first first direction data line DLH1 extending in the first direction D1, a first second direction data line DLV11, a second second direction data line DLV12 and a third second direction data line DLV13 which are connected to the first first direction data line DLH1. The first first direction data line DLH1 may have a contour. The display panel 100A may also include a second first direction data line DLH2 extending in the first direction D1, a fourth second direction data line DLV21, a fifth second direction data line DLV22 and a sixth second direction data line DLV23 which are connected to the second first direction data line DLH2. The display panel 100A may further include a third first direction data line DLH3 extending in the first direction D1, a seventh second direction data line DLV31, an eighth second direction data line DLV32 and a ninth second direction data line DLV33 which are connected to the third first direction data line DLH3. The third first direction data lines DLH3 may have a contour.

The first first direction data line DLH1 may include a first inclined portion and a second inclined portion along an inclined lower side of the display panel 100A. The third first direction data line DLH3 may include a third inclined portion along an inclined upper side of the display panel 100A.

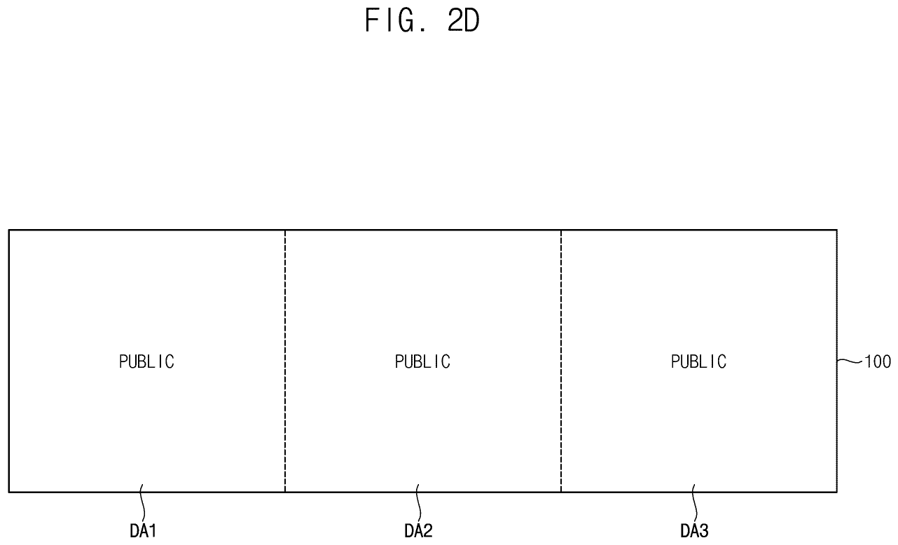

FIG. 5 is a diagram illustrating an example of the display panel 100B, the gate driver 300 and the data driver 500 of FIG. 1.

Referring to FIGS. 1, 2A to 2D and 5, a shape of the display panel 100B may not be a rectangle. An outline of the display panel 100B may include an inclined portion and a curved portion. In the present embodiment, the first direction data line may be partially formed or may be cut into two portions.

The first source group SG1 may include a plurality of first source driving chips S1, S2 and S3. The second source group SG2 may include a plurality of second source driving chips S4, S5 and S6. The third source group SG3 may include a plurality of third source driving chips S7, S8 and S9.

In the present embodiment, the first source group SG1 may further include first printed circuit boards PCB11 and PCB12 connected to the first source driving chips S1, S2 and S3. The second source group SG2 may further include a second printed circuit board PCB2 connected to the second source driving chips S4, S5 and S6. The third source group SG3 may further include a third printed circuit board PCB3 connected to the third source driving chips S7, S8 and S9.

As shown in FIG. 5, the display panel 100B may include a 1-1 first direction data line DLH11 extending in the first direction D1, a first second direction data line DLV11 which is connected to the 1-1 first direction data line DLH11, a 1-2 first direction data line DLH12 extending in the first direction D1 and spaced apart from the 1-1 first direction data line DLH11 in the first direction D1, a second second direction data line DLV12 and a third second direction data line DLV13 which are connected to the 1-2 first direction data line DLH12. As shown in FIG. 5, the 1-1 first direction data line DLH11 and the 1-2 first direction data line DLH12 are separated from each other. The display panel 100B may also include a second first direction data line DLH2 extending in the first direction D1, a fourth second direction data line DLV21, a fifth second direction data line DLV22 and a sixth second direction data line DLV23 which are connected to the second first direction data line DLH2. The display panel 100B may further include a third first direction data line DLH3 extending in the first direction D1, a seventh second direction data line DLV31 and an eighth second direction data line DLV32 which are connected to the third first direction data line DLH3, a fourth first direction data line DLH4 extending in the first direction D1 and a ninth second direction data line DLV4 which is connected to the fourth first direction data line DLH4.

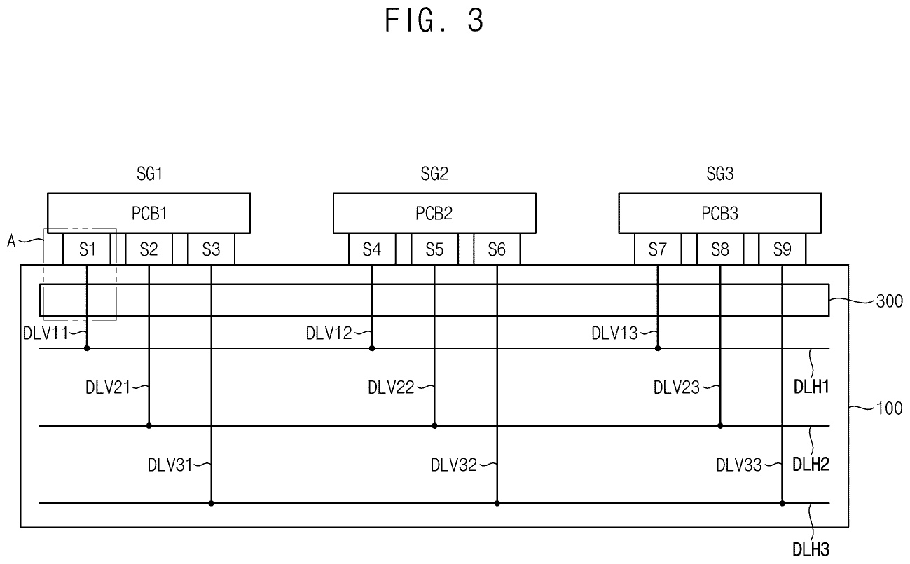

FIG. 6 is a diagram illustrating an example of an area A of FIG. 3.

Referring to FIGS. 1 to 6, second direction data lines DLV1, DLV2, DLV3, . . . may be connected to the source driving chip S1. Stages ST1, ST2, . . . , STP-1 and STP of the gate driver 300 may be disposed between the second direction data lines DLV1, DLV2, DLV3, . . . , respectively. For example, the stage ST1 may be disposed between the second direction data lines DLV1 and DLV2. In addition, the stage ST2 may be disposed between the second direction data lines DLV2 and DLV3. The gate lines GL1, GL2, . . . may be connected to the stages ST1, ST2, . . . , STP-1 and STP. For example, the gate line GL1 may be connected to the stage ST1, and the gate line GL2 may be connected to the stage ST2. The gate lines GL1, GL2, . . . may extend between the second direction data lines DLV1, DLV2, DLV3, . . . , respectively.

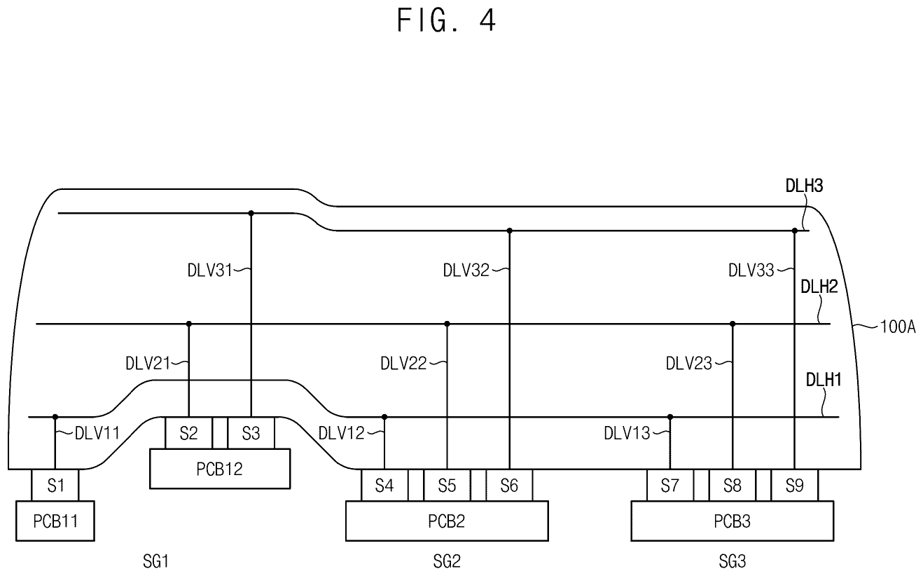

FIG. 7 is a diagram illustrating a connection between first direction data lines, gate lines and pixels of the display panel 100 of FIG. 1.

Referring to FIGS. 1 to 7, the display panel 100 may include a first pixel P11 and a second pixel P12 disposed in a first pixel row, a third pixel P21 and a fourth pixel P22 disposed in a second pixel row, a fifth pixel P31 and a sixth pixel P32 disposed in a third pixel row.

The first pixel P11 may be connected to an N-th gate line GLN and an M-th first direction data line DLHM. The second pixel P12 may be connected to an N+1-th gate line GLN+1 and the M-th first direction data line DLHM.

The third pixel P21 may be connected to the N-th gate line GLN and an M+1-th first direction data line DLHM+1. The fourth pixel P22 may be connected to the N+1-th gate line GLN+1 and the M+1-th first direction data line DLHM+1.

The fifth pixel P31 may be connected to the N-th gate line GLN and an M+2-th first direction data line DLHM+2. The sixth pixel P32 may be connected to the N+1-th gate line GLN+1 and the M+2-th first direction data line DLHM+2.

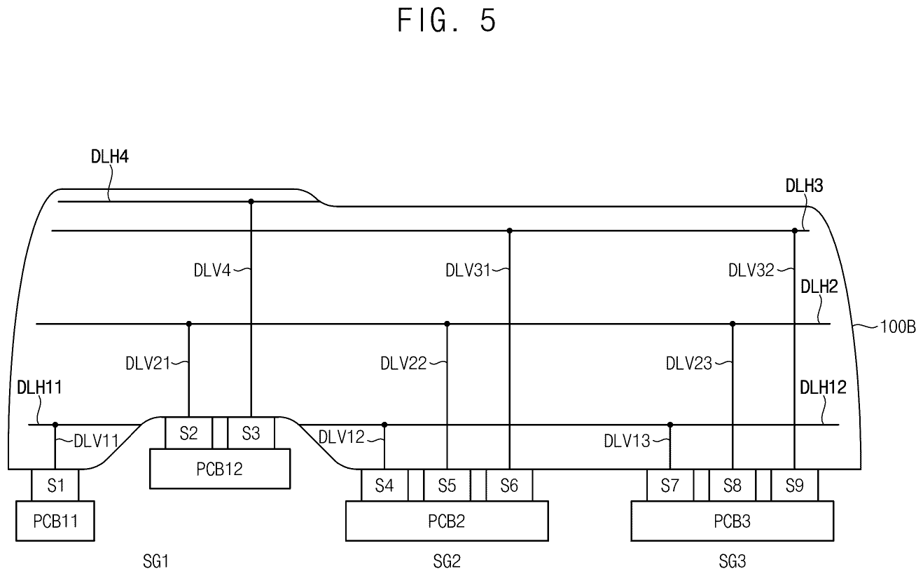

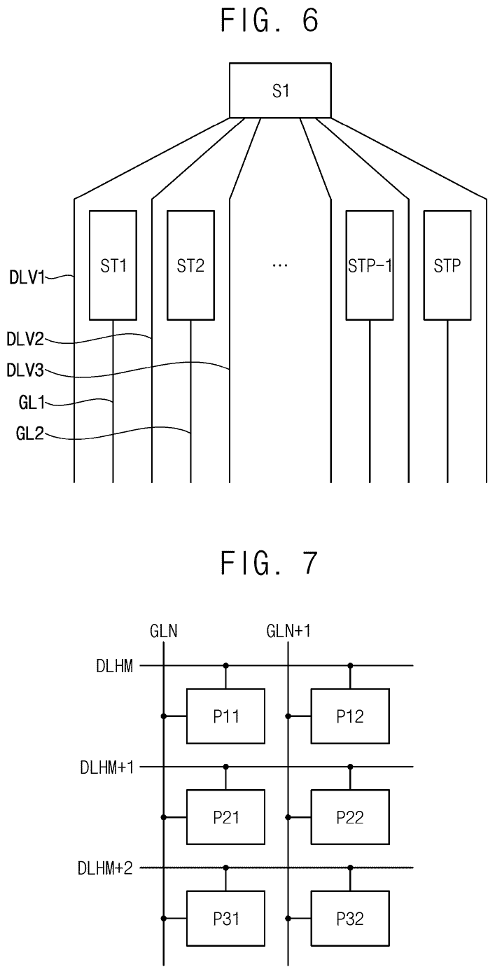

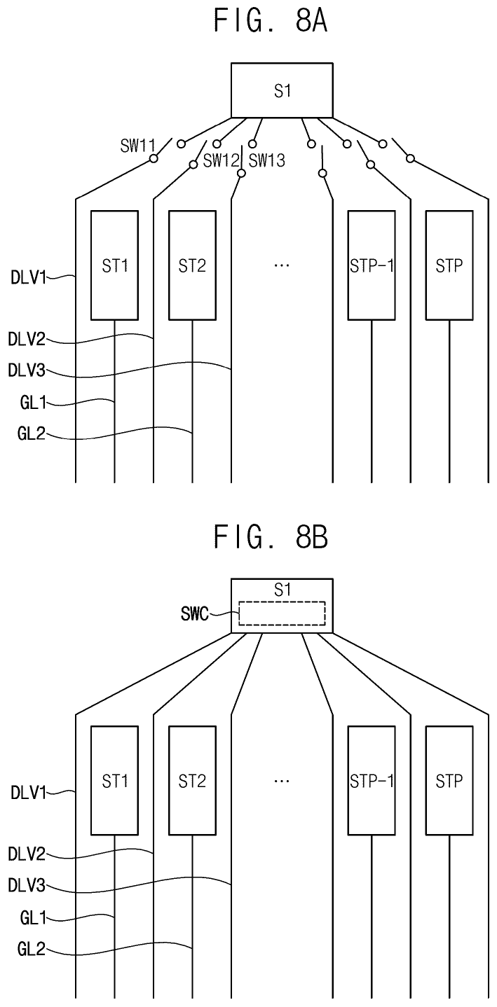

FIG. 8A is a diagram illustrating an example of an area A of FIG. 3. FIG. 8B is a diagram illustrating an example of an area A of FIG. 3. FIG. 9 is a timing diagram illustrating a method of controlling a switch of a first source group, a switch of a second source group and a switch of a third source group in the structures of FIGS. 8A and 8B. FIG. 10 is a timing diagram illustrating a method of controlling the switch of the first source group, the switch of the second source group and the switch of the third source group in the structures of FIGS. 8A and 8B.

As shown in FIG. 8A, the second direction data lines DLV1, DLV2, DLV3, . . . may be connected to the source driving chip S1. Stages ST1, ST2, . . . , STP-1 and STP of the gate driver 300 may be disposed between the second direction data lines DLV1, DLV2, DLV3, . . . , respectively. The gate lines GL1, GL2, . . . may be connected to the stages ST1, ST2, . . . , STP−1 and STP. The gate lines GL1, GL2, . . . may extend between the second direction data lines DLV1, DLV2, DLV3, . . . , respectively.

Source switches SW11, SW12, SW13, . . . may be disposed between the source driving chip S1 and the second direction data lines DLV1, DLV2, DLV3, . . . , respectively. For example, the source switch SW11 may be disposed between the source driving chip S1 and the second direction data line DLV1, the source switch SW12 may be disposed between the source driving chip S1 and the second direction data line DLV2 and the source switch SW13 may be disposed between the source driving chip S1 and the second direction data line DLV3. When the source switches SW11, SW12, SW13, . . . are turned on, the data voltages may be outputted through the second direction data lines DLV1, DLV2, DLV3, . . . corresponding to the source switches SW11, SW12, SW13, . . . . When the source switches SW11, SW12, SW13, . . . are turned off, the data voltages may not be outputted through the second direction data lines DLV1, DLV2, DLV3, corresponding to the source switches SW11, SW12, SW13, . . . .

As shown in FIG. 8A, the source switches SW11, SW12, SW13, . . . may be integrated on the display panel 100.

As shown in FIG. 8B, the source switches SW11, SW12, SW13, . . . may be integrated in the source driving chip. For example, the source switches SW11, SW12, SW13, . . . may be integrated in a switch circuit area SWC in the source driving chip.

Although the source switches corresponding to one source driving chip are illustrated in FIGS. 8A and 8B, source switches may be disposed between all the driving chips and all the second direction data lines, respectively.

For example, first source group switches SWG1 may be disposed between the first source driving chips S1, S2 and S3 and second direction data lines in the first display area DA1. For example, second source group switches SWG2 may be disposed between the second source driving chips S4, S5 and S6 and second direction data lines in the second display area DA2. For example, third source group switches SWG3 may be disposed between the third source driving chips S7, S8 and S9 and second direction data lines in the third display area DA3.

In an embodiment of FIG. 9, a data voltage VDATA is less than a target voltage in a first period DU1 and the data voltage VDATA is equal to or greater than the target voltage in a second period DU2. When the data voltage VDATA reaches the target voltage, only one source group (e.g., SG1) among the plurality of source groups may output the data voltage VDATA and the remaining source groups (e.g., SG2 and SG3) among the plurality of source groups may not output the data voltage VDATA so that the power consumption may be reduced. This is accomplished by keeping the first source group switches SWG1 on in the second period DU2 and by turning off the second source group switches SWG2 and the third source group switches SWG3 in the second period DU2, for example.

As shown in FIG. 9, the first source group switches SWG1 may be turned on, the second source group switches SWG2 may be turned on and the third source group switches SWG3 may be turned on in the first period DU1. The first source group switches SWG1 may be turned on, the second source group switches SWG2 may be turned off and the third source group switches SWG3 may be turned off in the second period DU2.

In this case, a first data voltage applied to the first source driving chips may be the same as a second data voltage applied to the second source driving chips for the same grayscale value.

In an embodiment of FIG. 10, a first period DU1 may be a predetermined overdriving period and a second period DU2 may be a predetermined normal driving period. Similarly, a third period DU3 may be the predetermined overdriving period and a fourth period DU4 may be the predetermined normal driving period. To compensate a charging rate, one source group (e.g., SG1) among the plurality of source groups may output a main data voltage and the remaining source groups (e.g., SG2 and SG3) among the plurality of source groups may output an overdriving data voltage greater than the main data voltage. In an early driving period (e.g., the overdriving period), all the source groups may output data voltages. In a late driving period (e.g., the normal driving period), only the source group outputting the main data voltage may be activated.

As shown in FIG. 10, the first source group switches SWG1 may be turned on, the second source group switches SWG2 may be turned on and the third source group switches SWG3 may be turned on in the first period DU1 and the third period DU3. The first source group switches SWG1 may be turned on, the second source group switches SWG2 may be turned off and the third source group switches SWG3 may be turned off in the second period DU2 and the fourth period DU4.

In this case, a first data voltage applied to the first source driving chips may be different from a second data voltage applied to the second source driving chips for the same grayscale value.

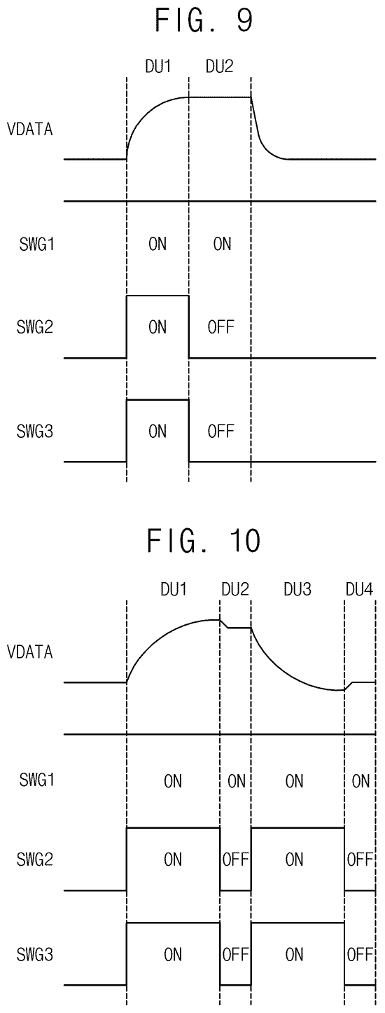

FIG. 11 is a diagram illustrating a connection between first direction data lines, gate lines and pixels of a display panel according to an embodiment of the present inventive concept.

Referring to FIG. 11, in the display panel 100 having a high horizontal resolution, a charging rate may be doubled through a 2D-1G structure.

The display panel 100 may include a first pixel P11 and a second pixel P12 disposed in a first pixel row and a third pixel P21 and a fourth pixel P22 disposed in a second pixel row.

The first pixel P11 may be connected to an N-th gate line GLN and a 1-1 first direction data line DLH11. The second pixel P12 may be connected to the N-th gate line GLN and a 1-2 first direction data line DLH12.

The third pixel P21 may be connected to the N-th gate line GLN and a 2-1 first direction data line DLH21. The fourth pixel P22 may be connected to the N-th gate line GLN and a 2-2 first direction data line DLH22.

The display panel 100 may further include a fifth pixel P31 and a sixth pixel P32 disposed in a third pixel row. The fifth pixel P31 may be connected to the N-th gate line GLN and a 3-1 first direction data line DLH31. The sixth pixel P32 may be connected to the N-th gate line GLN and a 3-2 first direction data line DLH32.

According to the present embodiment, the display panel 100 includes a structure in which a plurality of second direction data lines extending in the second direction D2 are connected to one first direction data line extending in the first direction D1 so that the number of the source driving chips may be reduced in the display panel 100 that has high resolution in the horizontal direction to reduce a manufacturing cost.

In addition, the gate driver 300 and the data driver 500 may extend horizontally across the display panel 100, particularly for the display panel 100 having the high horizontal resolution. This arrangement ensures that the content usage type and the scan direction are the same, allowing for the implementation of a frequency division driving method. In this method, the plurality of the display areas are driven at varying frequencies.

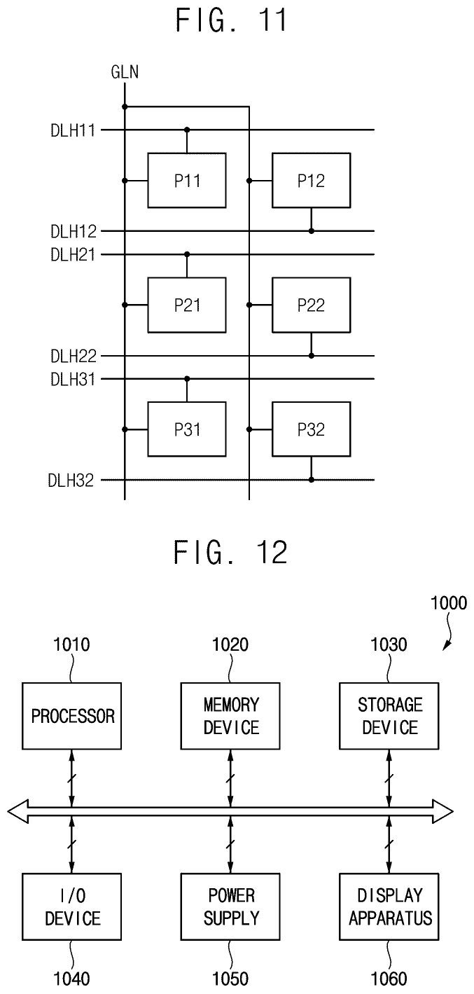

FIG. 12 is a block diagram illustrating an electronic apparatus according to an embodiment of the present inventive concept.

Referring to FIGS. 12, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, the electronic apparatus 1000 may be implemented as an automotive display system. However, the electronic apparatus 1000 is not limited thereto. For example, the electronic apparatus 1000 may be implemented as a smart phone, a cellular phone, a video phone, a smart pad, a smart watch, a tablet personal computer (PC), a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data and the input control signal to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

According to the display apparatus and the method of driving the display apparatus in the present inventive concept, the manufacturing cost of the display apparatus may be reduced and the frequency division driving method may be supported.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as set forth in the claims.

What is claimed is:

1. A display apparatus comprising:
a display panel including a first direction data line extending in a first direction, a plurality of second direction data lines extending in a second direction different from the first direction, a gate line extending in the second direction and a pixel connected to the first direction data line and the gate line;
a gate driver configured to apply a gate signal to the gate line; and
a data driver configured to apply a data voltage to the second direction data lines.

2. The display apparatus of claim 1, wherein the display panel comprises a first display area, a second display area disposed adjacent to the first display area in the first direction and a third display area disposed adjacent to the second display area in the first direction, and
wherein the first display area, the second display area and the third display area are driven with independent frequencies.

3. The display apparatus of claim 2, wherein a gate signal applied to the first display area, a gate signal applied to the second display area and a gate signal applied to the third display area are independently applied.

4. The display apparatus of claim 1, wherein the display panel comprises:
a first first direction data line extending in the first direction;
a first second direction data line, a second second direction data line and a third second direction data line which are connected to the first first direction data line;
a second first direction data line extending in the first direction;
a fourth second direction data line, a fifth second direction data line and a sixth second direction data line which are connected to the second first direction data line;
a third first direction data line extending in the first direction; and
a seventh second direction data line, an eighth second direction data line and a ninth second direction data line which are connected to the third first direction data line,
wherein the first direction data line includes the first first direction data line, the second first direction data line and the third first direction data line.

5. The display apparatus of claim 4, wherein the first first data line includes a first inclined portion and a second inclined portion, and
wherein the third first data line includes a third inclined portion.

6. The display apparatus of claim 1, wherein the display panel comprises:
a 1-1 first direction data line extending in the first direction;
a first second direction data line which is connected to the 1-1 first direction data line;
a 1-2 first direction data line extending in the first direction and spaced apart from the 1-1 first direction data line;
a second second direction data line and a third second direction data line which are connected to the 1-2 first direction data line;
a second first direction data line extending in the first direction;
a fourth second direction data line, a fifth second direction data line and a sixth second direction data line which are connected to the second first direction data line;
a third first direction data line extending in the first direction;
a seventh second direction data line and an eighth second direction data line which are connected to the third first direction data line;
a fourth first direction data line extending in the first direction; and
a ninth second direction data line which is connected to the fourth first direction data line,
wherein the first direction data line includes the 1-1 first direction data line, the 1-2 first direction data line, the second first direction data line, the third first direction data line and the fourth first direction data line.

7. The display apparatus of claim 1, wherein the gate driver extends along a first side of the display panel that extends in the first direction, and
wherein the data driver extends along the first side of the display panel.

8. The display apparatus of claim 7, wherein the gate driver is adjacent to a first side of the display panel, and
wherein the data driver includes a plurality of source driving chips connected to the first side of the display panel.

9. The display apparatus of claim 1, wherein the data driver includes a plurality of source driving chips connected to the display panel, and
the display apparatus further comprises a plurality of source switches disposed between the source driving chips and the second direction data lines.

10. The display apparatus of claim 9, wherein the source switches are integrated on the display panel.

11. The display apparatus of claim 9, wherein the source switches are integrated in the source driving chip.

12. The display apparatus of claim 1, wherein the data driver comprises a first source group corresponding to a first display area of the display panel and a second source group corresponding to a second display area of the display panel,
wherein the first source group comprises a plurality of first source driving chips, and
wherein the second source group comprises a plurality of second source driving chips,
the display apparatus further comprising a plurality of first source group switches disposed between the first source driving chips and the second direction data lines in the first display area and a plurality of second source group switches disposed between the second source driving chips and the second direction data lines in the second display area.

13. The display apparatus of claim 12, wherein the first source group switches are turned on and the second source group switches are turned on in a first period, and
wherein the first source group switches are turned on and the second source group switches are turned off in a second period.

14. The display apparatus of claim 13, wherein a data voltage is less than a target voltage in the first period,
wherein the data voltage is equal to or greater than the target voltage in the second period, and
wherein a first data voltage applied to the first source driving chips is the same as a second data voltage applied to the second source driving chips for the same grayscale value.

15. The display apparatus of claim 13, wherein the first period is an overdriving period,
wherein the second period is a normal driving period, and
wherein a first data voltage applied to the first source driving chips is different from a second data voltage applied to the second source driving chips for the same grayscale value.

16. The display apparatus of claim 1, wherein the display panel comprises a first pixel and a second pixel which are disposed in a first pixel row and a third pixel and a fourth pixel which are disposed in a second pixel row,
wherein the first pixel is connected to a first gate line and a 1-1 first direction data line,
wherein the second pixel is connected to the first gate line and a 1-2 first direction data line,
wherein the third pixel is connected to the first gate line and a 2-1 first direction data line,
wherein the fourth pixel is connected to the first gate line and a 2-2 first direction data line, and
wherein the first direction data line includes the 1-1 first direction data line, the 1-2 first direction data line, the 2-1 first direction data line and the 2-2 first direction data line.

17. A method of driving a display apparatus, the method comprising:
outputting a gate signal to a gate line of a display panel including a first direction data line extending in a first direction, a plurality of second direction data lines extending in a second direction different from the first direction, and a pixel connected to the first direction data line and the gate line, wherein the gate line extends in the second direction; and
outputting a data voltage to the second direction data lines.

18. The method of claim 17, wherein the display panel comprises a first display area, a second display area disposed adjacent to the first display area in the first direction and a third display area disposed adjacent to the second display area in the first direction, and
wherein the first display area, the second display area and the third display area are driven with independent frequencies.

19. The method of claim 18, wherein a gate signal applied to the first display area, a gate signal applied to the second display area and a gate signal applied to the third display area are independently applied.

20. The method of claim 17, wherein a data driver comprises a first source group corresponding to a first display area of the display panel and a second source group corresponding to a second display area of the display panel,
wherein the first source group comprises a plurality of first source driving chips,
wherein the second source group comprises a plurality of second source driving chips,
wherein a plurality of first source group switches disposed between the first source driving chips and the second direction data lines in the first display area are turned on and a plurality of second source group switches disposed between the second source driving chips and the second direction data lines in the second display area are turned on in a first period, and
wherein the first source group switches are turned on and the second source group switches are turned off in a second period.
